(19) United States
(12) Patent Application Publication
(10) Pub. No.: US 2017/0139102 A1
(43) Pub. Date: May 18, 2017

(54) BACKLIGHT MODULE, AND LIQUID CRYSTAL DISPLAY DEVICE

(71) Applicants: Le Holdings(Beijing)Co., Ltd., Beijing (CN); LE SHI ZHI XIN ELECTRONIC TECHNOLOGY (TIAN JIN) LIMITED, Tianjin (CN)

(72) Inventors: Changjia FU, Tianjin (CN); Fangdai YE, Tianjin (CN); Jinnan ZHANG, Tianjin (CN)

(21) Appl. No.: 15/232,394

(22) Filed: Aug. 9, 2016

Related U.S. Application Data
(63) Continuation of application No. PCT/CN2016/081919, filed on May 12, 2016.

(30) Foreign Application Priority Data
Nov. 13, 2015 (CN) 201510779856.8

(51) Int. Cl. F21V 8/00; G02F 1/1333

(52) U.S. Cl. CPC G02B 6/009; G02B 6/0085; G02F 1/133308; G02F 2001/13332

(57) ABSTRACT

The disclosure provides a backlight module and a liquid crystal display device. The backlight module, including a rear cover, a light guide plate, and an LED lamp assembly, the rear cover including an accommodation space in which the light guide plate is located, and the LED lamp assembly being located between a sidewall of the rear cover and a light entrance end face of the light guide plate, wherein a keep-space protrusion is arranged on the sidewall of the rear cover adjacent to the LED lamp assembly, and a screw hole configured to be threaded to a bezel is arranged on the keep-space protrusion.

### CROSS REFERENCE TO RELATED APPLICATIONS

This application is a continuation of International Application No. PCT/CN2016/081919, filed on May 12, 2016, which is based upon and claims priority to Chinese Patent Application No. 201510779856.8, filed on Nov. 13, 2015, the entire contents of which are incorporated herein by reference.

### TECHNICAL FIELD

The present disclosure relates to the field of display technologies, and particularly to a backlight module, and a liquid crystal display device.

### BACKGROUND

At present, a backlight module of a liquid crystal display device generally includes a Light Emitting Diode (LED) operating as light sources, and the backlight module can be categorized into a straight down type backlight module and a side light type backlight module dependent upon the positions where the light sources are distributed.

As illustrated in FIG. 1, the side light type backlight module in the liquid crystal display device generally includes a rear cover 11 including an accommodation space; a reflector 12, a light guide plate 13, and an optical sheet 14 arranged in that order in the accommodation space; a Light Emitting Diode (LED) lamp assembly 15 located between the sidewall of the rear cover 11 and the light entrance end face of the light guide plate 13; and a mold frame 16 located above the optical sheet 14 and assembled with the rear cover 11.

In addition to the backlight module, the liquid crystal display device generally further includes a liquid crystal panel 17 and a bezel 18, where the liquid crystal panel 17 is assembled to the front side of the backlight module, and the bezel 18 is assembled to the backlight module from the front side of the liquid crystal panel 17, and particularly threaded to the sidewall of the rear cover 11 through a screw 19 penetrating the sidewall of the bezel 18 and the sidewall of the mold frame 16.

A drawback in the prior art above lies in that if the liquid crystal display device is lightened, then the LED lamps in the LED lamp assembly 15 may radiate so much heat that there may be a significant increase in temperature of the part of the rear cover 11 close to the LED lamp assembly 15 so that the temperature of the screw 19 threaded to the rear cover 11 may also rise significantly, and since such a screw is typically exposed on the surface of the liquid crystal display device, if the screw is touched accidentally by a user, then he or she may feel discomfort and even burned.

### SUMMARY

Embodiments of the disclosure provide a backlight module, and a liquid crystal display device so as to prevent the temperature of a screw exposed on the surface of the liquid crystal display device from significantly rising.

In one aspect, embodiments of the disclosure provides a backlight module including a rear cover, a light guide plate, and an LED lamp assembly, the rear cover including an accommodation space in which the light guide plate is located, and the LED lamp assembly being located between a sidewall of the rear cover and a light entrance end face of the light guide plate, wherein a keep-space protrusion is arranged on the sidewall of the rear cover adjacent to the LED lamp assembly, and a screw hole configured to be threaded to a bezel is arranged on the keep-space protrusion.

In another aspect, embodiments of the disclosure provides a liquid crystal display device including a backlight module, a liquid crystal panel, a bezel, and a screw, wherein the backlight module includes a rear cover, a light guide plate, and an LED lamp assembly, the rear cover including an accommodation space in which the light guide plate is located, and the LED lamp assembly being located between a sidewall of the rear cover and a light entrance end face of the light guide plate, wherein a keep-space protrusion is arranged on the sidewall of the rear cover adjacent to the LED lamp assembly, and a screw hole configured to be threaded to a bezel is arranged on the keep-space protrusion, and wherein the liquid crystal panel is assembled to the front side of the backlight module, the bezel is assembled to front sides of the backlight module and the liquid crystal panel, and the screw is threaded with the screw hole on the keep-space protrusion of the rear cover by penetrating the sidewall of the bezel.

After the liquid crystal display device of the disclosure is lightened, since there is a significant keep-space interval between the screw in the screw hole and the LED lamp assembly, heat conduction between them can be greatly suppressed to thereby prevent the temperature of the screw from significantly rising so as to improve the experience of a user.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic diagram of a longitudinal section of a liquid crystal display device in the prior art;

FIG. 2 is a schematic diagram of a cross section of a backlight module assembled to a bezel according to a first embodiment of the disclosure;

FIG. 3 is a schematic diagram of a cross section of a backlight module assembled to a bezel according to a second embodiment of the disclosure;

FIG. 4 is a schematic diagram of a cross section of a backlight module assembled to a bezel according to a third embodiment of the disclosure;

FIG. 5 is a schematic diagram of a longitudinal section of the backlight module assembled to the bezel according to the third embodiment of the disclosure;

FIG. 6 is a schematic diagram of a cross section of a backlight module assembled to a bezel according to a fourth embodiment of the disclosure; and

FIG. 7 is a schematic diagram of a cross section of a backlight module assembled to a bezel according to a fifth embodiment of the disclosure.

### REFERENCE NUMERALS

In the prior art:
11—Rear cover; 12—reflector; 13—light guide plate; 14—optical sheet; 15—LED lamp assembly; 16—mold frame; 17—liquid crystal panel; 18—bezel; 19—screw.

In the embodiments of the disclosure:
51—Rear cover; 52—reflector; 53—light guide plate; 54—optical sheet; 55—LED lamp assembly; 511—keep-space protrusion; 551—heat sink; 552—LED BAR; 512—keep-space hole; 56—mold frame; 57—liquid crystal panel; 58—bezel; 59—screw.

### DETAILED DESCRIPTION

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

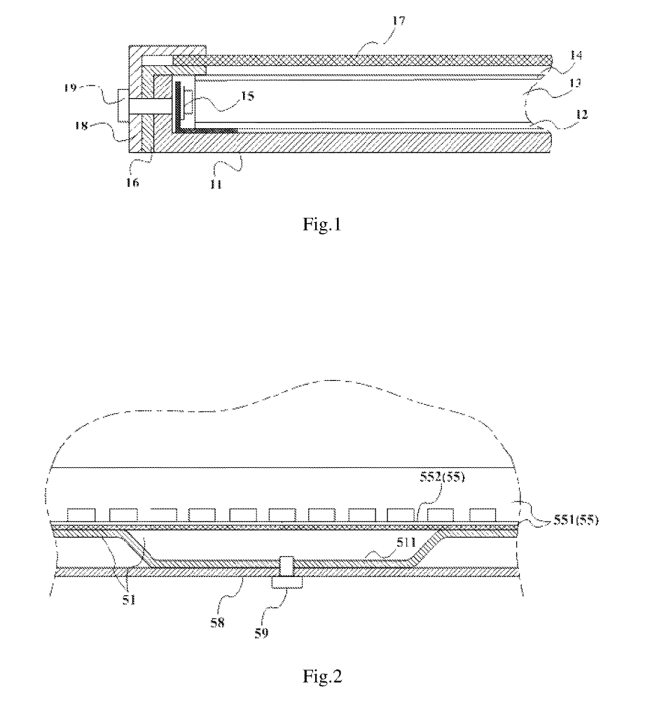

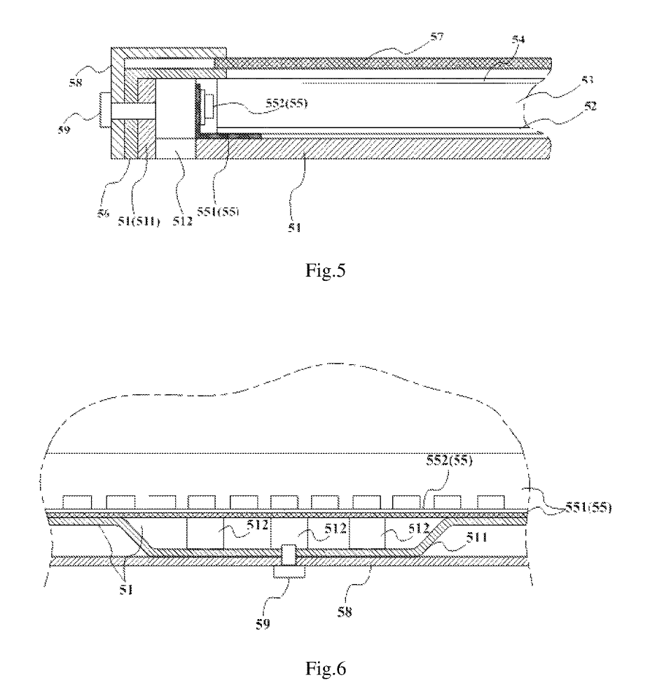

As illustrated in FIG. 2, a backlight module according to an embodiment of the disclosure includes a rear cover 51, a light guide plate (not illustrated, and see a light guide plate 53 illustrated in FIG. 5), and an LED lamp assembly 55, where the rear cover 51 includes an accommodation space surrounded by four sidewalls and a bottom wall of the rear cover 51, the light guide plate is located in the accommodation space, the LED lamp assembly 55 is located between a sidewall of the rear cover 51 and a light entrance end face of the light guide plate, a keep-space protrusion 511 is arranged on the sidewall of the rear cover 51 adjacent to the LED lamp assembly 55, and a screw hole (not illustrated, and corresponding to the position where a screw 59 is arranged) configured to be threaded to a bezel 58 is arranged on the keep-space protrusion 511.

As can be apparent from the position where the LED lamp assembly 55 is arranged, the backlight module according to the embodiment of the disclosure is a side light type backlight module, where light emitted by the LED lamps in the LED lamp assembly 55 is transmitted into the light guide plate from the light entrance end face of the light guide plate. The LED lamp assembly 55 includes a heat sink 551 and an LED BAR 552 connected with each other, where the heat sink 551 will not be limited to any particular type, for example, it can be an L-shaped heat sink or a flat heat sink, and the heat sink is preferably made of an aluminous material with good thermal conductivity and light weight, and a plurality of LED lamps are arranged on the LED BAR 552. In addition to the components above, the backlight module typically further includes a reflector 52, an optical sheet 54, a mold frame 56, etc., as illustrated in FIG. 5.

In the technical solution according to the embodiment of the disclosure, the keep-space protrusion 511 is arranged on the sidewall of the rear cover 51 adjacent to the LED lamp assembly 55, and the screw hole threaded to the bezel 58 is arranged on the keep-space protrusion 511; and after a liquid crystal display device including the backlight module is lightened, since there is a significant keep-space interval between the screw 59 in the screw hole and the LED lamp assembly 55, heat conduction between them can be greatly suppressed to thereby prevent the temperature of the screw 59 from significantly rising so as to avoid a user touching accidentally the screw 59 from feeling discomfort, thus improving the experience of the user.

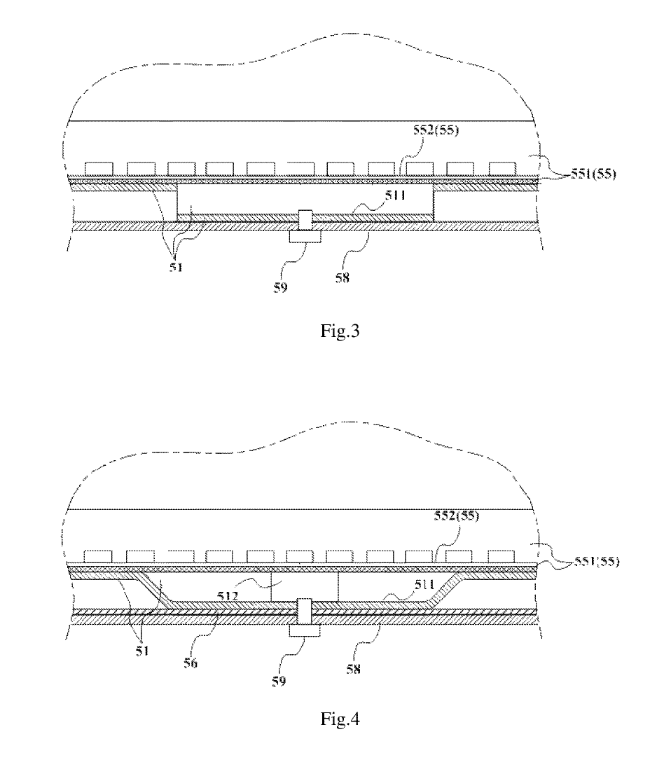

Further referring to FIG. 2, the keep-space protrusion 511 is shaped in a trapezoid keep-space protrusion to thereby accommodate the structural strength requirement of the rear cover 51, where the keep-space protrusion can be formed by punching the rear cover. Additionally the keep-space protrusion 511 is structured symmetrical to the screw hole so that heat can be conducted substantially uniformly on both sides of the screw hole, thus making the advantageous effect above of the disclosure more pronounced. As illustrated in FIG. 3, in another embodiment of the disclosure, the keep-space protrusion 511 is separated from the other sections of the sidewall of the rear cover 51 so that a better effect of preventing the temperature of the screw from significantly rising can also be achieved.

Referring to an embodiment illustrated in FIG. 4 and FIG. 5, a keep-space hole 512 is arranged on the section of the bottom wall of the rear cover 51 between the heat sink 551 and the keep-space protrusion 511. The keep-space hole 512 can be arranged to decrease the area of heat conduction between the screw hole and the LED lamp assembly 55 to thereby further prevent the temperature of the screw 59 from significantly rising. Preferably the keep-space hole 512 is located below the area of the screw hole facing the LED lamp assembly 55, and since a path of heat conduction is the shortest, and the rate of heat conduction is the highest, in the section of the bottom wall of the rear cover 51 below the area of the screw hole facing the LED lamp assembly 55, the keep-space hole 512 can be opened here to thereby greatly suppress heat conduction between them so as to more effectively prevent the temperature of the screw 59 from significantly rising. The size of the keep-space hole 512 in the lengthy direction of the LED lamp assembly 55 is preferably no less than three times the diameter of the screw to thereby suppress heat conduction as much as possible, but the structural strength of the rear cover 51 needs to be taken into account, so it may not be advisable to preset a too large size of the keep-space hole 512 in the lengthy direction of the LED lamp assembly 55, but this size shall be preset while considering the overall structural size and strength requirement of the rear cover 51. It shall be noted that the number of keep-space holes 512 will not be limited to one, but a plurality of keep-space holes 512 can be arranged as illustrated in FIG. 6 as long as the structural strength of the rear cover 51 is satisfactory.

In the embodiment illustrated in FIG. 4 and FIG. 5, the screw 59 is threaded to the sidewall of the rear cover 51 by penetrating the sidewall of the bezel 58 and the sidewall of the mold frame 56. In another embodiment of the disclosure, the keep-space protrusion 511 is not shielded by the sidewall of the mold frame after the mold frame 56 is assembled to the rear cover 51, so the screw 59 is threaded directly with the screw hole on the keep-space protrusion 511 by penetrating the sidewall of the bezel 58.

Referring to FIG. 5, an embodiment of the disclosure further provides a liquid crystal display device including the backlight module according to any one of the technical solutions above, a liquid crystal panel 57, a bezel 58, and a screw 59, where the liquid crystal panel 57 is assembled to the front side of the backlight module, the bezel 58 is assembled to the front sides of the backlight module and the liquid crystal panel 57, and the screw 59 is threaded with the screw hole on the keep-space protrusion 511 of the rear cover 51 by penetrating the sidewall of the bezel 58 and the sidewall of the mold frame 56.

The display device will not be limited to any particular type, for example, the display device can include a liquid crystal TV set, a liquid crystal display, a liquid crystal screen of a mobile terminal, etc. As described above, the screw can alternatively be threaded directly with the screw hole on the keep-space protrusion of the rear cover by penetrating the sidewall of the bezel, according to the designed structure of the mold frame of the backlight module.

It shall be noted that in order to connect the bezel securely with the rear cover, the sidewalls of the rear cover on which no light is incident may also be screwed to the bezel, and since the sidewalls of the rear cover on which no light is incident are further from the LED BAR, and the temperature of those sidewalls may less rise due to the LED lamps, they may be structured consecutively flat as in the prior art instead of being structured as described above.

After the liquid crystal display device according to the embodiment of the disclosure is lightened, since there is a significant keep-space interval between the screw 59 in the screw hole and the LED lamp assembly 55, heat conduction between them can be greatly suppressed to thereby prevent the temperature of the screw 59 from significantly rising so as to improve the experience of the user.

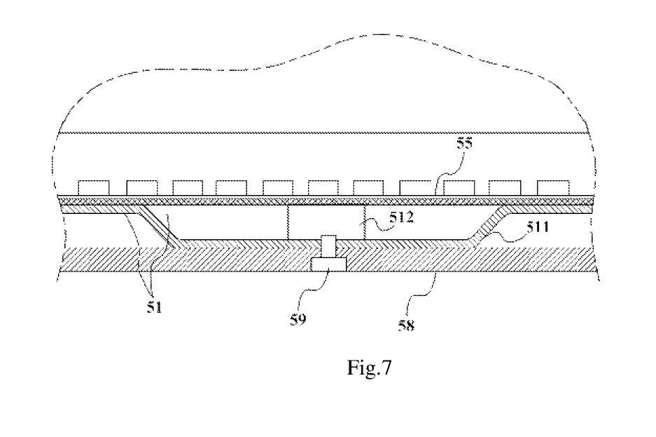

Preferably as illustrated in FIG. 7, the screw 59 is a countersunk head screw, and the screw hole is a countersunk head screw hole. A nut of the countersunk head screw does not exceed the surface of the sidewall of the bezel 58 so that the nut will not be readily seen on the appearance of the liquid crystal display device, thus making the liquid crystal display device more pleasing in appearance; and moreover the nut of the countersunk head screw should not be readily touched by the user, thus further improving the experience of the user.

Lastly it shall be noted that the respective embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

What is claimed is:

1. A backlight module, comprising a rear cover, a light guide plate, and an LED lamp assembly, the rear cover comprising an accommodation space in which the light guide plate is located, and the LED lamp assembly being located between a sidewall of the rear cover and a light entrance end face of the light guide plate, wherein:
a keep-space protrusion is arranged on the sidewall of the rear cover adjacent to the LED lamp assembly, and a screw hole configured to be threaded to a bezel is arranged on the keep-space protrusion.

2. The backlight module according to claim 1, wherein the keep-space protrusion is a trapezoid keep-space protrusion, or the keep-space protrusion is separated from sections of the sidewall of the rear cover other than the keep-space protrusion.

3. The backlight module according to claim 1, wherein the keep-space protrusion is structured symmetrical to the screw hole.

4. The backlight module according to claim 1, wherein the LED lamp assembly comprises a heat sink and an LED BAR connected with each other, and a keep-space hole is arranged on the section of the bottom wall of the rear cover between the heat sink and the keep-space protrusion.

5. The backlight module according to claim 2, wherein the LED lamp assembly comprises a heat sink and an LED BAR connected with each other, and a keep-space hole is arranged on the section of the bottom wall of the rear cover between the heat sink and the keep-space protrusion.

6. The backlight module according to claim 3, wherein the LED lamp assembly comprises a heat sink and an LED BAR connected with each other, and a keep-space hole is arranged on the section of the bottom wall of the rear cover between the heat sink and the keep-space protrusion.

7. The backlight module according to claim 4, wherein the keep-space hole is located below the area of the screw hole facing the LED lamp assembly.

8. The backlight module according to claim 7, wherein the size of the keep-space hole in the lengthy direction of the LED lamp assembly is no less than three times the diameter of the screw.

9. The backlight module according to claim 4, wherein the heat sink comprises an L-shaped heat sink or a flat heat sink.

10. A liquid crystal display device, comprising a backlight module, a liquid crystal panel, a bezel, and a screw, wherein the backlight module comprises a rear cover, a light guide plate, and an LED lamp assembly, the rear cover comprising an accommodation space in which the light guide plate is located, and the LED lamp assembly being located between a sidewall of the rear cover and a light entrance end face of the light guide plate, wherein a keep-space protrusion is arranged on the sidewall of the rear cover adjacent to the LED lamp assembly, and a screw hole configured to be threaded to a bezel is arranged on the keep-space protrusion, and wherein:
the liquid crystal panel is assembled to a front side of the backlight module, the bezel is assembled to front sides of the backlight module and the liquid crystal panel, and the screw is threaded with the screw hole on the keep-space protrusion of the rear cover by penetrating the sidewall of the bezel.

11. The liquid crystal display device according to claim 10, wherein the screw is a countersunk head screw, and the screw hole is a countersunk head screw hole.

12. The liquid crystal display device according to claim 10, wherein the liquid crystal display device comprises a liquid crystal TV set, a liquid crystal display, or a liquid crystal screen of a mobile terminal.

13. The liquid crystal display device according to claim 11, wherein the liquid crystal display device comprises a liquid crystal TV set, a liquid crystal display, or a liquid crystal screen of a mobile terminal.

14. The liquid crystal display device according to claim 10, wherein the keep-space protrusion is a trapezoid keep-space protrusion, or the keep-space protrusion is separated from sections of the sidewall of the rear cover other than the keep-space protrusion.

15. The liquid crystal display device according to claim 10, wherein the keep-space protrusion is structured symmetrical to the screw hole.

16. The liquid crystal display device according to claim 10, wherein the LED lamp assembly comprises a heat sink and an LED BAR connected with each other, and a keep-space hole is arranged on the section of the bottom wall of the rear cover between the heat sink and the keep-space protrusion.

17. The liquid crystal display device according to claim 16, wherein the keep-space hole is located below the area of the screw hole facing the LED lamp assembly.

18. The liquid crystal display device according to claim 17, wherein the size of the keep-space hole in the lengthy direction of the LED lamp assembly is no less than three times the diameter of the screw.

19. The liquid crystal display device according to claim 16, wherein the heat sink comprises an L-shaped heat sink or a flat heat sink.
